(19) United States
(12) Patent Application Publication
(10) Pub. No.: US 2010/0263755 A1
(43) Pub. Date: Oct. 21, 2010

(54) FUEL DISTRIBUTOR VALVE

(75) Inventors: Robert A. J. TAYLOR, Derby (GB); Anthony PIDCOCK, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, LONDON (GB)

(21) Appl. No.: 12/726,924

(22) Filed: Mar. 18, 2010

(30) Foreign Application Priority Data
Apr. 20, 2009 (GB) 0906649.9

(51) Int. Cl. F16L 55/00; A47J 27/09; F01L 3/10

(52) U.S. Cl. 137/613; 251/338; 251/337

(57) ABSTRACT

A fuel distributor valve (19) of a type suitable for use in the fuel supply system of a gas turbine engine is disclosed. The valve comprises: a valve body (22) through which a bore (24) extends between a fuel inlet (22) and a fuel outlet (23); a first valve seat (28) and associated valve member (30) provided across the bore (24), the first valve seat (28) defining at least one fuel-flow-port (26) and the valve member (30) being moveable between a closed position in which it substantially seals against the first valve seat (28) to close the or each fuel-flow-port (26) and an open position in which it is spaced from the first valve seat (28) to permit the flow of fuel through the or each fuel-flow-port (26) in a direction flowing from the fuel inlet (22) towards the fuel outlet (23). The valve is characterised by the provision of a second valve seat (29) and associated second valve member (31), wherein the second valve seat (29) defines at least one air-flow-port (27) and the second valve member (31) is moveable independently of the first valve member (30) between a closed position in which it substantially seals against the second valve seat (29) to close the or each air-flow-port (27) and an open position in which it is spaced from the second valve seat (29) to permit the flow of air through the or each air-flow-port (27) in a direction substantially opposed to said flow of fuel. The distributor valve (19) preferably takes the form of a weight type distributor valve in which the first valve member (30) is provided in the form of a weight.

The present invention relates to a fuel distributor valve, and more particularly relates to a fuel distributor valve suitable for use in the fuel supply system of a gas turbine engine.

Modern gas turbine engines, particularly those used for propulsion in the aero industry, conventionally incorporate a combustion system comprising an annular combustion chamber defined between an inner and outer casing. The combustion chamber is configured so as to be open towards the engine's compressor at its forward end, and open towards the engine's turbine nozzles at its rear end. A plurality of fuel injectors are provided in a generally radially-arranged array around the combustion chamber, each injector being connected to a fuel manifold extending generally around the combustion chamber and being arranged to inject liquid fuel into the combustion chamber in order to mix with and ignite compressed air exiting the compressor. The resultant hot gases then expand through, and thereby drive, the engine's turbines.

In the case of an aero-engine having fuel injectors arranged in a substantially vertical ring about a horizontal central axis, the effect of the gravity head occurring across the fuel supply manifold is such that the fuel injectors located below the level of the central axis will experience a higher local fuel pressure than the fuel injectors located above the level of the central axis. Significant pressure differentials have been found to occur across the diameter of the combustion chamber in this manner in a number of circumstances, namely; i) at low fuel flow rates (e.g at low engine speeds or high altitudes) when fuel pressure may be low, ii) when the combustion chamber has a large diameter, as in the case of modern large aero-engines, and iii) when the combustion chamber is fed by a large number of fuel injectors.

Unless measures are taken to compensate for local fuel pressure differences, variations in fuel flow rates through injectors around the combustion chamber will occur. Such variations in fuel flow rates are particularly problematic at low power operation as they can have adverse effects on the performance of the engine. It is therefore important that an equal amount of fuel is supplied to each fuel injector under all operating conditions, to ensure that all sectors of the combustor operate in the same way giving consistency to the temperature distribution experienced by the turbines.

For large diameter combustion chambers provided on large aero-engines, a flow distributor arrangement is required to compensate for the gravity head across the fuel supply manifold. One previously-proposed form of flow distributor arrangement uses a plurality of so-called weight type distributors (WTDs), each being associated with a respective fuel injector (or group of injectors). Also, at low powers some engines require a slight bias of fuel—much less than could be achieved without weight distributors—to lessen the light-round and provide a ‘softer’ start

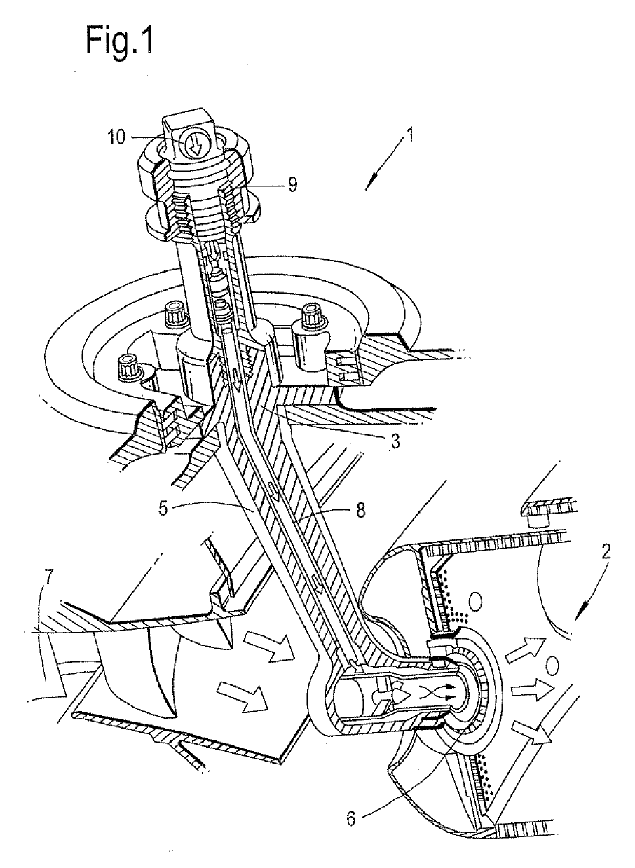

FIG. 1 shows the general arrangement of a conventional fuel injector of an air-spray nozzle type, incorporating a weight type distributor. The injector 1 is shown at a position in an upper sector of the combustion chamber 2, and will thus experience a relatively low local fuel pressure compared to a similar injector located at the bottom of the combustion chamber. The injector comprises a lower housing 3 which is threadedly connected to an upper housing 4. The lower housing 3 comprises an injector stalk 5 which extends radially inwardly towards the central rotational axis of the engine and terminates with an injector head 6 in the form of an air-spray nozzle located downstream of the engine's high pressure compressor 7 so as to be exposed to the flow of compressed air exiting the compressor, and extending into the forward region of the combustion chamber 2. The injector stalk is generally hollow and contains an internal fuel tube 8 along which fuel is supplied to the injector head from the region of the upper housing 4. The upper housing 4 is also generally hollow and comprises a port 9 to which the end of a fuel supply pipe 10 is connected. A weight type distributor valve 11 is provided within the hollow of the upper housing. As will thus be appreciated, fuel is supplied to the injector via the fuel supply pipe 10, from where the fuel passes through the weight type distributor valve 11 and on through the fuel tube 8 to the injector head 6.

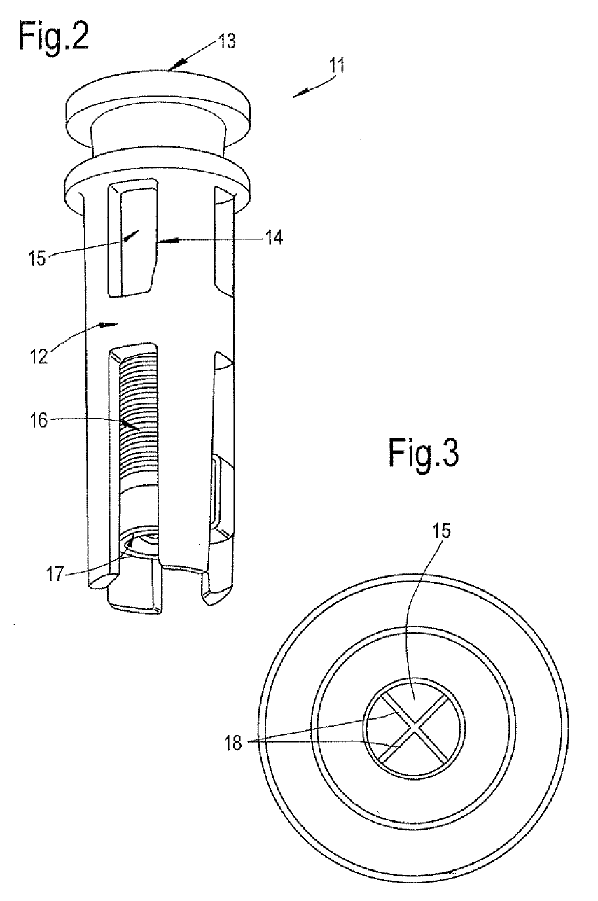

FIGS. 2 and 3 illustrate a conventional weight type distributor valve in further detail. The distributor valve comprises a hollow cylindrical housing 12 having a fuel inlet port 13 provided at one end, and at least one fuel outlet port 14 provided through its sidewall. An annular valve seat is provided around the inlet port 13. A. valve member in the form of a cylindrical weight 15 is provided within the housing, the weight being arranged for sliding movement along the axis of the housing. The weight is urged towards a closed position in which it substantially seals against the valve seat under the action of a biasing spring 16. The spring usually takes the form of a helically wound compression spring provided between the valve weight 15 and an adjusting nut 17 threadedly engaged within the end of the housing. The adjusting nut may be rotated relative to the housing in order to adjust the biasing force provided by the spring.

When fuel is supplied to the inlet port 13 with sufficient pressure, the valve weight 15 is moved out of engagement with the valve seat, against the biasing force of the spring 16, thereby allowing the fuel to flow past the valve weight and through the outlet port 14. The valve closes when the fuel pressure drops below a predetermined level.

Each fuel injector 1 is provided with a respective weight type distributor valve of the type illustrated in FIG. 2, with each distributor valve being arranged such that its spring acts to urge the valve weight radially outwardly towards the valve seat. The spring force of each weight distributor valve is thus always directed radially outwardly. Thus, in the case of injectors located in an upper sector of the combustion chamber such as the one illustrated in FIG. 1, the spring force opposes the force of gravity acting on the weight. In contrast, in the case of injectors located in the lower sector of the combustion chamber (which would thus be inverted relative to the orientation illustrated in FIG. 1), the spring force acts in addition to the force of gravity on the weight. The resultant combined force acting to close the distributor valves against the in-flow of fuel is thus greater in the case of lower injectors (which are subject to higher fuel pressures due to the effect of the gravity head across the fuel manifold) than in the case of the higher injectors (which are subject to lower local fuel pressures). The size and density of the moving weight in the valve can be specified so that its mass is equivalent to half the static pressure head of the fuel in the supply manifold to compensate for the full manifold head, since the upper and lower weights act in opposite directions. By careful adjustment of the spring force of each weight distributor valve, the variations in local fuel pressure around the combustion chamber can thus be compensated.

It is advantageous to configure the fuel supply system such that when the engine is shut down by cutting the supply of fuel to the injectors, the fuel supply manifold becomes completely drained of residual fuel, to avoid any remaining fuel subsequently dripping back into the fuel spray nozzles of the injectors which can cause the formation of damaging carbon deposits inside the air heatshield gaps of the nozzles (so-called “carbon-jacking”). It has therefore been proposed previously to provide small grooves across the end face of the valve weights 15, in the region where the valve weights engage against their respective valve seats. FIG. 3 illustrates a valve weight provided with two such grooves 18 which intersect the in the form of a cross. On engine shut-down, the supply of fuel to the injectors is cut and so each weight distributor valve snaps shut under the action of the biasing spring 16. However, the small grooves 18 permit the back-flow of air from the combustion chamber, through the valve and into the fuel manifold, to allow drainage of the manifold to occur.

However, it has been found that in practice it is often not possible to make the grooves in the valve weights sufficiently large to permit the flow of sufficient air to give speedy drainage of the fuel from the manifold, without also adversely affecting the performance of the engine during operation. In order to ensure acceptable performance of the weight distributor valves during normal engine operation, the grooves must be kept small, with the result that the fuel can take a significant time to drain from the fuel system on shut-down. For some engines, this drainage time has been found to be as long as approximately 45 seconds to drain the manifold but up to 10 minutes from the whole system since the pipework from the manifold to the fuel injector often contains U-bends that trap the fuel and the current weight distributors can slow the drainage of this fuel back through the fuel injectors to well after shut-down, by which time the engine air pressure has typically decayed to such an extent as to be insufficient to blow all the fuel from the manifold and associated pipe-work. Residual fuel remaining in the system can then drip back into the fuel spray nozzles of the injectors resulting in the formation of damaging carbon inside the nozzles.

It is therefore an object of the present invention to provide an improved fuel distributor valve for a gas turbine engine.

According to the present invention, there is provided a fuel distributor valve for a gas turbine engine, the valve comprising: a valve body through which a bore extends between a fuel inlet and a fuel outlet; a first valve seat and associated valve member provided across the bore, the first valve seat defining at least one fuel-flow-port and the valve member being moveable between a closed position in which it substantially seals against the first valve seat to close the or each fuel-flow-port and an open position in which it is spaced from the first valve seat to permit the flow of fuel through the or each fuel-flow-port in a direction flowing from the fuel inlet towards the fuel outlet; the valve being characterised by: a second valve seat and associated second valve member, wherein the second valve seat defines at least one air-flow-port and the second valve member is moveable independently of the first valve member between a closed position in which it substantially seals against the second valve seat to close the or each air-flow-port and an open position in which it is spaced from the second valve seat to permit the flow of air through the or each air-flow-port in a direction substantially opposed to said flow of fuel.

Preferably the first valve member is provided in the form of a weight having significant mass relative to the second valve member. Such an arrangement thus takes the form of an improved weight type distributor (WTD) valve.

The second valve seat and associated second valve member are preferably provided across said bore.

The first valve member is preferably biased towards its closed position against the first valve seat.

Similarly, the second valve member is preferably biased towards its closed position against the second valve seat.

The first and or second valve member may be biased towards its closed position by a respective spring, such as a helically-wound compression spring or the like. In a preferred arrangement, the two valve members are arranged so as to move in opposite directions towards their respective closed positions.

Said first and second valve seats may be combined, for example as a single structure, component or formation.

Preferably, the valve further comprises a seat structure extending substantially across said bore, the seat structure defining said first valve seat on one side and said second valve seat on the opposing side.

In such an arrangement, the or each said fuel-flow-port is preferably defined through a first region of said seat structure, and the or each said air-flow-port is preferably defined through a second region of said seat structure.

Said second region is optionally substantially annular and surrounds said first region.

Said seat structure is preferably provided in the form of a substantially annular shoulder extending inwardly of said bore and defining a single centrally located fuel-flow-port therethrough.

Preferably, said first valve member is configured so as not to occlude the or each air-flow-port, and said second valve member is configured so as not to occlude the or each said fuel-flow-port.

Said second valve member may substantially annular in form, and configured so as to have a central aperture to permit the flow of fuel therethrough. In such an arrangement, it is preferable for said central aperture and said single fuel-flow-port to be substantially co-aligned when said second valve member adopts its closed position.

So that the invention may be more readily understood, and so that further features thereof may be appreciated, an embodiment of the invention will now be described by way of example with reference to the accompanying drawings in which:

FIG. 1 is a cross-sectional view taken through a generally conventional fuel injector of a type suitable for use on a gas turbine engine (discussed above);

FIG. 2 is a perspective view showing a previously-proposed form of weight type distributor valve for use in the injector of FIG. 1 (discussed above);

FIG. 3 is a perspective view showing the drainage grooves of the weight distributor valve shown in FIG. 2 (discussed above);

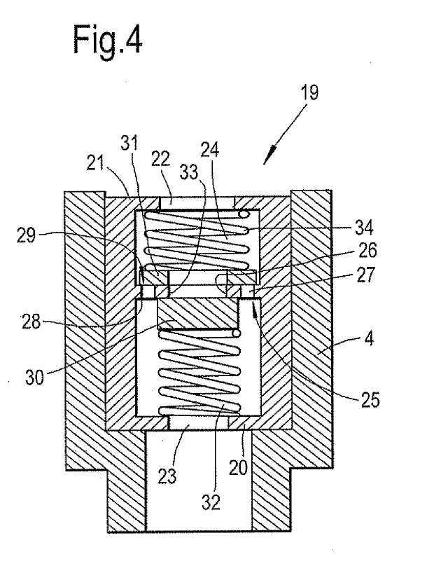

FIG. 4 is a schematic cross-sectional view taken through a fuel distributor valve in accordance with the present invention, showing the valve located within a fuel injector housing and in a closed configuration;

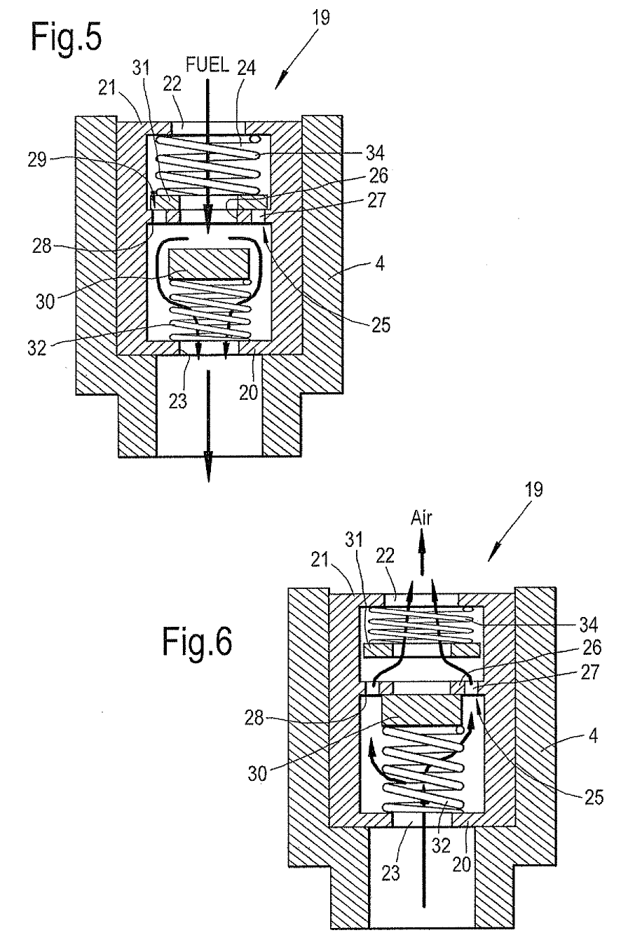

FIG. 5 is a view corresponding generally to that of FIG. 4, but illustrating the distributor valve in an open configuration in which fuel is permitted to flow through the valve; and

FIG. 6 is a view corresponding generally to that of FIG. 5, but illustrating the distributor valve in an alternate configuration in which the valve is closed to the flow of fuel but open to a backflow of air.

Referring now in more detail to FIG. 4, there is illustrated an improved fuel distributor valve 19 in accordance with the present invention. The distributor valve 19 is illustrated in position within the interior volume of an upper housing 4 of a fuel injector arrangement generally similar to that illustrated in FIG. 1. The upper housing 4 is configured so as to have an inwardly stepped configuration presenting an upwardly directed annular shoulder 20 on which the dual distributor valve 19 rests. As will be appreciated, FIG. 4 illustrates the fuel distributor valve 19 in an orientation corresponding to that of a fuel injector provided in the upper region of a gas turbine engine, generally in accordance with the orientation of the arrangement illustrated in FIG. 1.

The distributor valve 19 comprises a substantially cylindrical housing in the form of a valve body 21 having a fuel inlet opening 22 formed at one end and a fuel outlet opening 23 formed at the opposite end. A central bore 24 extends all the way through the valve body 21, between the fuel inlet opening 22 and the fuel outlet opening 23.

At a generally central position, located between the inlet opening 22 and outlet opening 23 there is provided a valve seat structure 25 which extends generally across the bore 24. The valve seat structure 25 effectively takes the form of an annular shelf extending inwardly from the inner side wall of the valve body 21 so as to define a central aperture 26. As will be described in further detail below, the central aperture serves as a fuel-flow-port. Arranged in a generally annular array around the central aperture 26, there are provided a plurality of spaced apart air-flow-ports 27 extending completely through the seat structure 25.

The seat structure 25 effectively defines two oppositely directed annular surfaces 28,29. The first surface 28 is directed towards the fuel outlet opening 23 (i.e. downwardly in the orientation illustrated in FIG. 4), whilst the second surface 29 is directed towards the fuel inlet opening 22 (i.e. upwardly in the orientation illustrated in FIG. 4). The first surface 28 serves as a first valve seat and co-operates with a first valve member 30, whilst the second surface 29 serves as a second valve seat and co-operates with a second valve member 31.

The first valve member 30 is provided within the bore so as to be moveable axially therein, in the space defined between the seat structure 25 and the fuel outlet opening 23. The first valve member 30 is substantially cylindrical in form and in common with conventional weight type distributor valves is provided in the form of a weight having significant mass (at least in relation to the mass of the second valve member). FIG. 4 illustrates the first valve member 30 in a closed position in which it bears against the first valve seat defined by the first surface of the seat structure 25 so as to substantially seal against the first valve seat, thereby closing the fuel-flow-port defined by the central aperture 26. The first valve member 30 is biased towards the closed position illustrated in FIG. 4 under the action of a first biasing spring 32 which, in the arrangement illustrated, takes the form of a helically wound compression spring which bears against the first valve member 30 at one end and bears against the valve body, generally around the fuel outlet opening 23 at its opposite end.

It is to be noted that when the first valve member 30 adopts its closed position illustrated in FIG. 4, the valve member 30 is effective to close the central fuel-flow-port 26, but does not occlude any of the air-flow ports 27 provided through the seat structure 25.

Turning now to consider in more detail the second valve member 31, it will be noted that the second valve member 31 has a generally annular form and is provided for movement in a generally axial direction within the bore 24, in the space defined between the seat structure 25 and the fuel inlet opening 22. In particular, it is to be noted that the second valve member 31 is provided with a central aperture 33 which is substantially aligned with the aperture defining the fuel-flow-port 26 through the seat structure 25. Indeed, in the arrangement illustrated in FIG. 4, the central aperture 33 formed through the second valve member 31 is of substantially identical diameter to the fuel-flow-port 26.

FIG. 4 illustrates the second valve member 31 in a closed position in which it bears against the second surface 29 of the seat structure 25 so as to substantially seal against the second valve seat, thereby closing the air-flow-ports 27, whilst leaving the central fuel-flow-port 26 substantially unoccluded by virtue of the central aperture 33. The second valve member 31 is biased towards its closed position illustrated in FIG. 4 by a second biasing spring 34 which again preferably takes the form of a helically wound compression spring, and which is arranged to bear against the second valve member 31 at one end and to bear against the valve body, generally around the fuel inlet opening 22, at the other end.

It is to be appreciated that FIG. 4, which illustrates both the first valve member 30 and the second valve member 31 in their respective closed positions, shows the distributor valve 19 in an inoperable condition, for example in the case of a cool and inactive engine. In contrast, FIG. 5 illustrates the distributor valve 19 in an operative condition during normal operation of the gas turbine engine, during which fuel is pumped through the distributor valve 19 so as to flow under pressure through the fuel inlet opening 22 in a flow direction indicated generally by the arrows in FIG. 5, towards the fuel outlet opening 23. Under the combined forces arising from the local fuel pressure applied to the distributor valve, and the force of gravity acting on the first valve member 31, the valve member 31 is displaced towards the fuel outlet opening 23, against the biasing force of the first spring 32, so as to move out of engagement with the first valve seat defined by the first surface 28 of the seat structure 25. Thus, the first valve member 31 is caused to move from the closed position illustrated in FIG. 4 to the open position illustrated in FIG. 5, which is effective to open the fuel-flow-port 26 defined through the seat structure 25, thereby permitting the flow of fuel through the fuel-flow-port 26, around the first valve member 31, through the first biasing spring 32 and from there through the fuel outlet opening 23 and onwards towards the injector head of the fuel injector arrangement. As will be appreciated, in the case of a fuel distributor valve provided within a fuel injector arrangement in a lower region of the gas turbine engine, the local fuel pressure (which in that case will be higher than in the upper arrangement illustrated in FIG. 5) will act against the force of gravity in order to move the first valve member 31 to its open position to allow the flow of fuel into the combustion chamber of the engine.

During normal operation of the gas turbine engine, during which fuel flows in the manner described above, it is to be noted that the flow of fuel through the fuel inlet opening 22 and into the valve bore 24 is effective to urge the second valve member 31 into even firmer contact with its associated valve seat as defined by the second surface 29 of the seat structure 25. Thus, during normal operation of the gas turbine engine, the air-flow apertures 27 remain closed by the second valve member 31.

However, when the engine is shut down by cutting flow of fuel to the distributor valve 19, the local fuel pressure within the distributor valve drops significantly such that the biasing force of the first spring 32 is no longer overcome by the local fuel pressure. The first spring 32 is thus effective to urge the first valve member 31 towards its closed position in which it seals against the first valve seat defined by the first surface 28 of the seat structure 25, thereby closing the fuel-flow-port 26. As will also be appreciated, with no fuel being directed into the bore 24 through the fuel inlet opening 22, the forces urging the second valve member 31 towards its closed position are reduced, with the remaining restoring force being provided only by the second biasing spring 34. However, the spring force of the second spring 34 is carefully selected so as to allow the second valve member 34 to move from its closed position illustrated in FIGS. 4 and 5 to an open position as illustrated in FIG. 6 under the pressure arising from the back-flow of hot air which, in the absence of a flow of fuel, flows from the combustion chamber and through the distributor valve 19 as illustrated by the arrows in FIG. 6. Thus, after the flow of fuel through the distributor valve has been cut, the second valve member 31 is urged against the force of the second biasing spring 34 to an open position in which the back-flow of hot air is allowed to flow through the air-flow-ports and hence into the fuel manifold, thereby allowing pressures to equalise such that residual fuel is allowed to drain from the manifold and associated flow passages. As the pressure of the air within the combustion chamber reduces after engine shut-down, a point will be reached at which the air pressure is no longer sufficient to overcome the force of the second biasing spring 34, at which time the second valve member 31 will be urged to its closed position, thereby closing the air-flow-ports 27 and returning the valve 19 to the condition illustrated in FIG. 4.

It has been found that by providing the distributor valve 19 with a second valve arrangement responsive to the back-flow of air in the opposite direction to the flow of fuel through the first valve arrangement, the back-flow of air is more effective in permitting drainage of residual fuel from the fuel supply lines, thereby preventing potentially damaging formation of carbon deposits on the fuel injectors.

Whilst the distributor valve of the present invention has been described above with reference to a particular embodiment, it is to be appreciated that certain modifications or alterations could be made to the arrangement without departing from the scope of the present invention. One aspect to which such modifications or alterations could be made is the configuration of the seat structure 25. Whilst the seat structure 25 illustrated in the drawings and described in detail above is provided with a single, relatively large fuel-flow-port 26 in a central position and a plurality of relatively small air-flow ports 27 arranged in an annular array around the fuel-flow-port, other arrangements are possible and could offer advantages in certain installations. For example, the single fuel-flow-port 26 could be replaced with a plurality of smaller fuel-flow ports arranged in a group through a first, central region of the seat structure 25, with the air-flow-ports 27 provided in a group through a second, annular region of the seat structure 25 surrounding the first region. Alternatively, the relative positions of the fuel-flow-ports 26 and the air-flow-ports 27 could even be transposed such that the air-flow ports (or even just a single air-flow port) are provided through the central region of the seat structure, with the fuel-flow-ports arranged around the outside. Of course, in the event that the air-flow-ports and the fuel-flow-ports are transposed in this way, then the configurations of the two valve members 30, 31 would also need to be changed accordingly.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

1. A fuel distributor valve for a gas turbine engine, the valve comprising: a valve body through which a bore extends between a fuel inlet and a fuel outlet; a first valve seat and associated valve member provided across the bore, the first valve seat defining at least one fuel-flow-port and the valve member being moveable between a closed position in which it substantially seals against the first valve seat to close the or each fuel-flow-port and an open position in which it is spaced from the first valve seat to permit the flow of fuel through the or each fuel-flow-port in a direction flowing from the fuel inlet towards the fuel outlet; the valve being characterised by: a second valve seat and associated second valve member, wherein the second valve seat defines at least one air-flow-port and the second valve member is moveable independently of the first valve member between a closed position in which it substantially seals against the second valve seat to close the or each air-flow-port and an open position in which it is spaced from the second valve seat to permit the flow of air through the or each air-flow-port in a direction substantially opposed to said flow of fuel.

2. A fuel distributor valve according to claim 1, wherein the first valve member is provided in the form of a weight having significant mass relative to the second valve member.

3. A fuel distributor valve according to claim 1, wherein the second valve seat and associated second valve member are provided across said bore.

4. A fuel distributor valve according to claim 1, wherein the first valve member is biased towards its closed position against the first valve seat.

5. A fuel distributor valve according to claim 1, wherein the second valve member is biased towards its closed position against the second valve seat.

6. A fuel distributor valve according to claim 4, wherein the, or at least one, said valve member is biased towards its closed position by a respective spring.

7. A fuel distributor valve according to claim 1, wherein the two said valve members are arranged so as to move in opposite directions towards their respective closed positions.

8. A fuel distributor valve according to claim 1, wherein said first and second valve seats are combined.

9. A fuel distributor valve according to claim 1, further comprising a seat structure extending substantially across said bore, the seat structure defining said first valve seat on one side and said second valve seat on the opposing side.

10. A fuel distributor valve according to claim 9, wherein the or each said fuel-flow-port is defined through a first region of said seat structure, and the or each said air-flow-port is defined through a second region of said seat structure.

11. A fuel distributor valve according to claim 10, wherein said second region is substantially annular and surrounds said first region.

12. A fuel distributor valve according to claim 11, wherein said seat structure is provided in the form of a substantially annular shoulder extending inwardly of said bore and defining a single centrally located fuel-flow-port.

13. A fuel distributor valve according to claim 10, wherein said first valve member is configured so as not to occlude the or each air-flow-port, and said second valve member is configured so as not to occlude the or each said fuel-flow-port.

14. A fuel distributor valve according to claim 13, wherein said second valve member is substantially annular in form, having a central aperture to permit the flow of fuel therethrough.

15. A fuel distributor valve according to claim 14, wherein said central aperture and said single fuel-flow-port are substantially co-aligned when said second valve member adopts its closed position.
